(19) United States
(12) Patent Application Publication
(10) Pub. No.: US 2025/0340146 A1
(43) Pub. Date: Nov. 6, 2025

(54) CLOSE LOOP BATTERY CHARGE CURRENT CONTROL

(71) Applicant: Cummins Inc., Columbus, IN (US)

(72) Inventors: Omkar A. Harshe, Columbus, IN (US); Joseph E. Paquette, Columbus, IN (US)

(21) Appl. No.: 18/021,934

(22) PCT Filed: Aug. 21, 2020
(86) PCT No.: PCT/US2020/047346

§ 371 Date: Feb. 17, 2023

(51) Int. Cl. B60L 53/62; B60L 1/00

(52) U.S. Cl. CPC B60L 53/62; B60L 1/00

(57) ABSTRACT

A method to charge a vehicle having a battery operable to power an electric traction system includes: connecting the battery (20) to a charger (9), wherein the electric vehicle (10) includes a powertrain controller communicatively connected to the battery (20) and the charger (9) when the battery (20) is connected to the charger (9); and by the charge controller: determine a feed-forward demand current; receive a measured battery current indicative of a current received by the battery (20) from the charger (9); determine a current feedback based on an integral of a difference between the measured battery current and the feed-forward demand current; and determine a target current based on the sum of the feed-forward demand current and the current feedback; and command the charger (9) to supply the target current to the electric vehicle (10).

### CROSS-REFERENCE TO RELATED APPLICATIONS

None.

### TECHNICAL FIELD

The present disclosure relates to devices and methods to charge batteries, and methods to control electric vehicle supply equipment.

### BACKGROUND

It is desirable to charge batteries of electric vehicles fast with a charger by providing the maximum amount of power the batteries can safely receive. The electric vehicles may include accessories and the accessories may be powered by the batteries on an electric high voltage bus, or bus, or the battery charger when connected to the bus.

During charging of a battery, a target current is calculated based on the battery power limits and accessory load demand. Different high voltage devices, made by different manufacturers, may be connected to the battery directly or via the bus and draw power while the battery is being charged. The charger may not have awareness of the power consumption of the accessories. Additionally, current sensing inaccuracies in different components could lead to errors in the calculation of the target current, which in turn could result in under/over current flow to the batteries.

New control techniques are desirable to improve the accuracy of the target current while meeting battery charge power limits.

### SUMMARY

In aspects of the disclosure an electric vehicle having a battery and a powertrain controller, a powertrain controller, and a method of charging the battery by the powertrain controller, are provided.

The disclose embodiments ensure that current demanded by the battery is delivered to the battery to meet it's charge current requirement, irrespective of scenarios which would typically impede such delivery.

In a first aspect, a method to charge a vehicle having a battery operable to power an electric traction system comprises: connecting the battery (20) to a charger (9), wherein the electric vehicle (10) includes a powertrain controller communicatively connected to the battery (20) and the charger (9) when the battery (20) is connected to the charger (9); and by the charge controller: determine a feed-forward demand current; receive a measured battery current indicative of a current received by the battery (20) from the charger (9); determine a current feedback based on an integral of a difference between the measured battery current and the feed-forward demand current; and determine a target current based on the sum of the feed-forward demand current and the current feedback; and command the charger (9) to supply the target current to the electric vehicle (10).

In a second aspect, a powertrain controller to control charging of an electric vehicle having a battery operable to power an electric traction system comprises charging logic operable to: determine a feed-forward demand current; receive a measured battery current indicative of a current received by the battery (20) from the charger (9); determine a current feedback based on an integral of a difference between the measured battery current and the feed-forward demand current; determine a target current based on the sum of the feed-forward demand current and the current feedback; and generate a target current command for the charger (9) to supply the target current to the electric vehicle.

In a third aspect, an electric vehicle comprises: an electric traction system (12); a battery (20) connected to power the electric traction system (12); and a powertrain controller (40) to control charging of the battery (20) when the battery (20) is connected to a charger (9), the powertrain controller (40) comprising charging logic (42) operable to: determine a feed-forward demand current; receive a measured battery current indicative of a current received by the battery (20) from the charger (9); determine a current feedback based on an integral of a difference between the measured battery current and the feed-forward demand current; determine a target current based on the sum of the feed-forward demand current and the current feedback; and generate a target current command for the charger (9) to supply the target current to the electric vehicle.

### BRIEF DESCRIPTION OF DRAWINGS

The above-mentioned embodiments and additional variations, features and advantages thereof will be further elucidated by the following illustrative and nonlimiting detailed description of embodiments disclosed herein with reference to the appended drawings, wherein:

FIG. 1 is a schematic diagram of a vehicle electrically connected to a charger;

FIG. 2 is a block diagram of an embodiment of battery charge logic; and

FIG. 3 is a schematic diagram of the embodiment of the charge logic of FIG. 3.

In the drawings, corresponding reference characters indicate corresponding parts, functions, and features throughout the several views. The drawings are not necessarily to scale and certain features may be exaggerated in order to better illustrate and explain the disclosed embodiments.

### DESCRIPTION OF EMBODIMENTS

For the purposes of promoting an understanding of the principles of the disclosure, reference will now be made to the embodiments illustrated in the drawings, which are described below. The embodiments disclosed below are not intended to be exhaustive or limit the disclosure to the precise form disclosed in the following detailed description.

Different scenarios are possible during charging of a battery of an electric vehicle. As used herein, an electric vehicle comprises a vehicle with an electric powertrain. Generally, an electric powertrain comprises electric motors connected, directly or indirectly, to a traction system. A traction system may comprise wheels, for example. The wheels may drive continuous treads, or tracks, for example. The powertrain may be entirely electric, e.g. an all-electric vehicle, or may include, in addition to the electric motors, a combustion engine, e.g. a hybrid electric vehicle. Thus, as used herein, hybrid and all-electric vehicles are types of electric vehicles. The charging current may be limited by the electric vehicle supply equipment (EVSE). The EVSE may comprise a charger, charger cable, a connector of the charger cable, etc. The charging current may also be limited by the battery. In the case where charging is limited by the battery, charging may be affected during cold warm-up, start of charging, pack integration, under/over delivery by the EVSE, and accessory reporting inaccuracies. Logic described below addresses these scenarios.

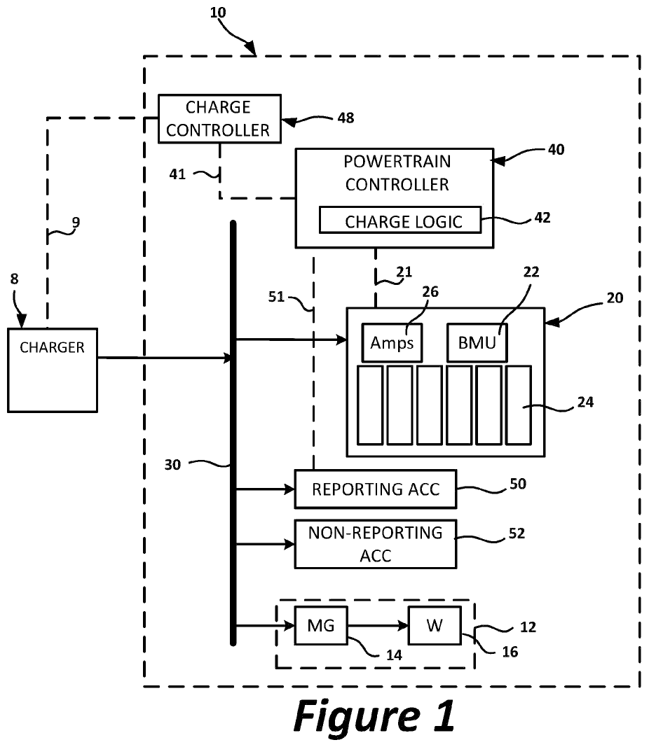

FIG. 1 is a schematic diagram of a vehicle 10 electrically connected to a charger 8. Electric vehicle 10 comprises: an electric traction system 12 including a motor-generator 14 and wheels 16 which may be connected to motor-generator 14 by an axle (not shown) or directly; a battery 20 connected to a bus 30 to power electric traction system 12; and a powertrain controller 40 to control charging of battery 20 when bus 30 is connected to charger 8. A charge controller 48 establishes communications, as is known in the art, between the powertrain controller and the charger. The charge controller receives a charge command from the powertrain controller and provides it to the charger. The charge controller may monitor sensor signals and perform safety and performance checks and determine faults based thereon. For example, the charge controller may determine a fault if charging started but a physical connection between the charger and the vehicle fails to be detected or is detected to be outside safe boundaries. Thus, the charge controller functions as the communication interface between the charger and the powertrain controller.

A reporting accessory 50 and a non-reporting accessory 52 are also shown, drawing power from bus 30. Communication lines 9, 21, 41, and 51 enable powertrain controller 40 to communicate with charger 9, battery 20, and reporting accessory 50, respectively. Preferably the communication lines convey digital data between the components. A CAN bus may be implemented to provide the communication lines. In a preferred embodiment a first CAN bus may be implemented to provide communication lines 21 and 51 and a second CAN bus may be implemented to provide communication line 41. Any serial or parallel communication scheme and protocol know in the art may be used to provide communication line 9.

As the name implies, reporting accessory 50 is operable to communicate information to powertrain controller 40. Such information may include identification, current demand, high or low voltage power draw, and other information. The identification information may convey a maximum current capacity of the accessory, for example. The current demand may be dynamic, such that the current demanded by reporting accessory 50 fluctuates. Reporting accessory 50 may be an air conditioning system, for example, and the current demand may vary based on a temperature of the vehicle compared to a target temperature. By reporting current demand to powertrain controller 40, reporting accessory 50 enables powertrain controller 40 to more accurately determine the target current to generate the charge command to the charger. On the other hand, the load of a non-reporting accessory may be dynamic and unknown, resulting in the charger underdelivering current to the battery thus reducing the charging time from a faster charging time that results by the implementation, as discussed herein, of a feedback control. The charge command may also take into account the charger's capability to deliver the current. The charge command indicates to the charger what level of current to output to the vehicle, which should be sufficient to optimally charge the battery and also power the accessories.

Battery 20 may comprise one or more battery packs comprising a battery management unit (BMU) 22 and battery modules 24. BMUs are generally well known. Temperature, voltage, and other sensors may be provided to enable BMU 22 to manage the charging and discharging of battery modules 24 without exceeding their limits, to detect and manage faults, and to perform other known functions. Battery 20 has a battery charge power limit that should not be exceeded. The bus voltage may be referred to as the system voltage. Via the communication line BMU 22 may convey to powertrain controller 40 information about the battery, including the battery charge power limit, temperature, faults, etc. Battery 20 may include a current sensor 26 to provide a measured current value to the BMU. The measured current value is used by the feedback control to affect the charge command provided to the charger. The current sensor may also be located elsewhere. Multiple current sensors may also be provided, each associated with a battery module of the battery, the sum of the measured currents being the measured current of the battery.

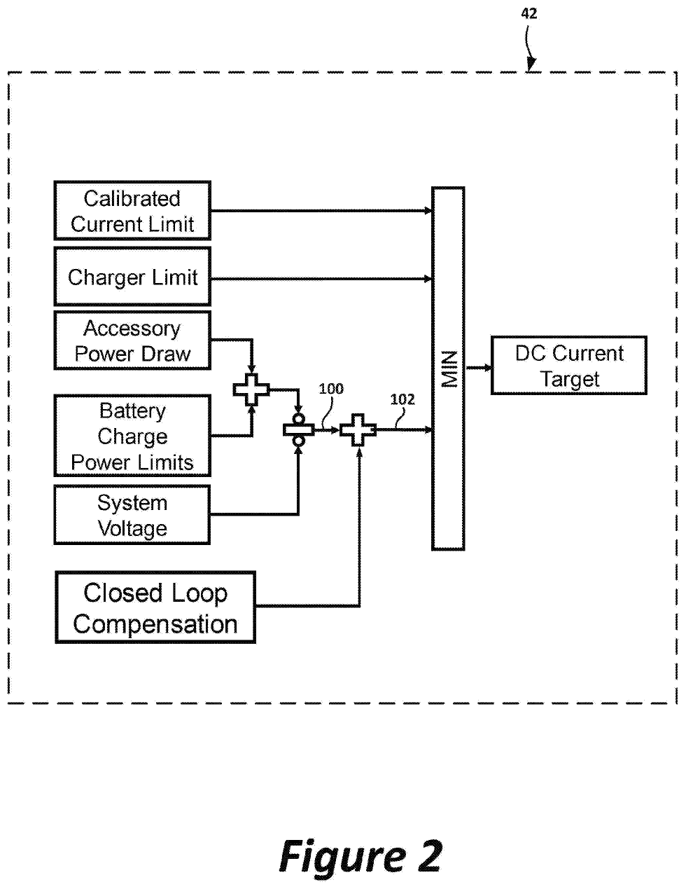

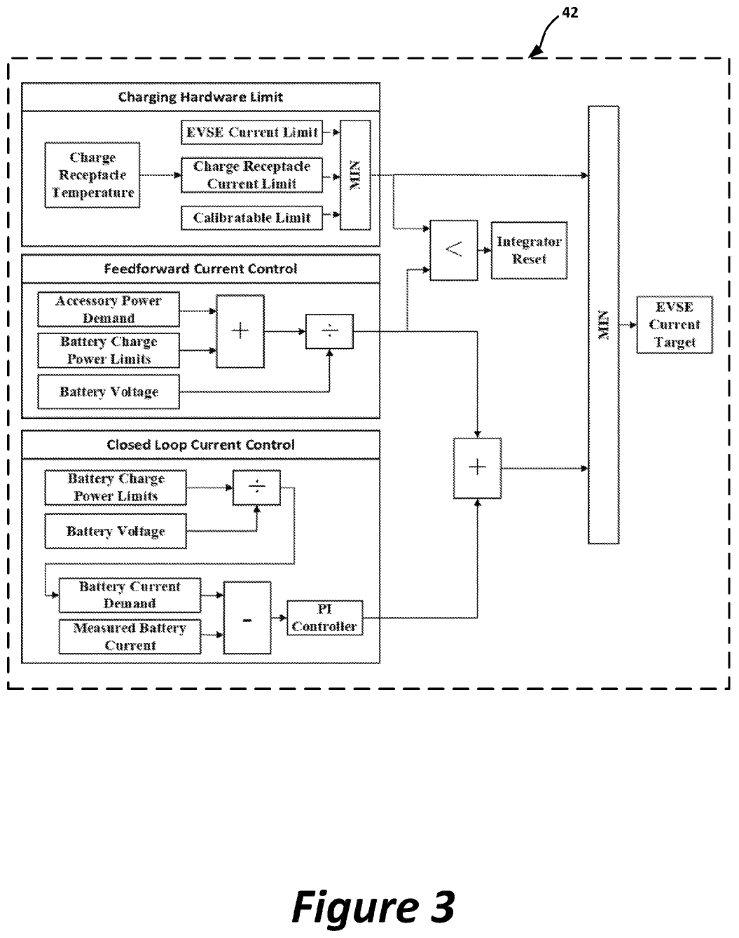

Powertrain controller 40 comprises charge logic 42 operable to determine a command for the charger to supply target current to the battery, as described below with reference to FIGS. 2 and 3. Charge logic 42 may also be integrated with a controller of BMU 22 or provided in a stand-alone controller communicatively coupled to powertrain controller 40. The term “logic” as used herein includes software and/or firmware comprising processing instructions executing on one or more programmable processors, application-specific integrated circuits, field-programmable gate arrays, digital signal processors, hardwired logic, or combinations thereof, which may referred to as “controllers”. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash memory), or any other tangible medium capable of storing information.

Powertrain controller 40 may include functionality well known in the art of electric vehicles. Such functionality may include logic to control the motor-generator by determining a desirable torque and commanding the battery to provide power commensurate with said toque, and may include functionality for range-extension, regeneration, torque ratio control if a combustion engine is provided in an hybrid electric vehicle, etc. Powertrain controller 40 may also control all the high voltage accessories coupled to the bus. The high voltage bus may have a voltage greater than 500 volts DC, potentially in a range of 550-850 volts DC.

Powertrain controller 40 may include functionality well known in the art of electric vehicles. Such functionality may include logic to control the motor-generator by determining a desirable torque and commanding the battery to provide power commensurate with said toque, and may include functionality for range-extension, regeneration, torque ratio control if a combustion engine is provided in an hybrid electric vehicle, etc.

Feed-forward current is the power demand divided by the bus voltage. The power demand includes the battery demand plus the accessories' demand. The battery demand, or power limit, may be provided by the BMU of the battery. A feedback current control includes a proportional-integral (PI) module that compares the battery demand current to the measured current received by the battery to generate a feedback value. The feed-forward current is then adjusted based on the feedback value. If the accessories are non-reporting accessories, the feedback control may increase the target current until the battery demand is satisfied, which requires a target current higher than the battery demanded current to compensate at least for the unknown demand of the non-reporting accessories. The BMU may communicate the battery demand based on the state-of-charge of the battery and other battery characteristics, as is known.

FIG. 2 is a block diagram of an embodiment of battery charge logic 42 comprising feed-forward and the feedback current control. The minimum of a calibrated current limit, a charger current limit, and the feedback compensated feed-forward current is the target current 102. The feed-forward current 100 is the calculated power demand, exemplified as the accessory power draw plus the battery charge power limit divided by the bus, or system, voltage. The battery limit is specified by the BMU, as is known, such that as state-of-charge (SOC) increases the power demanded by the battery, or battery limit, decreases. The battery limit may also be based on cell temperatures and voltages of the cells in the battery packs. The feedback current control includes closed loop compensation that compares the battery demand to the measured current provided to the battery by the charger to generate a feedback value and adjusts the feed-forward current 100 based on the feedback value to generate a feedback-adjusted current value 102 which, if it is less than the charging hardware limit, becomes the current target, also described as the EVSE current target. The calibratable current limit may be a limit that is calibrated to protect non-smart components of the charging system such as plugs and cables, and calibration of the calibratable current limit may be part the vehicle's configuration. The calibratable current limit may be provided by the BMU to the charging logic or may reside in the charging logic as, for example, the content of a memory cell. The accessory power draw of reporting accessories may be known and used in the calculation of the calculated power demand but the accessory power draw of non-reporting accessories is not known.

FIG. 3 is a block diagram of a variation of the embodiment described with reference to FIG. 2, of battery charge logic comprising feed-forward and feedback current control. A charging hardware limit is the minimum of the EVSE current limit, the charge receptacle current limit, and a calibratable current limit. The charge receptacle current limit is set to protect a connector or plug of the charger that is connected to the vehicle to connect the charger to the bus. The calibratable current limit may be provided as a safety mechanism, as discussed above.

The feed-forward current control determines the feed-forward current based on the sum of a battery charge power limit and an accessory power draw, or demand, of an accessory/(ies) electrically connected to the battery, divided by the bus voltage. If the charging hardware limit is less than the feed-forward current, the integrator of the closed loop current control is reset, e.g. set to zero, thus negating the feedback.

The closed loop current control determines the battery current demand and compares it to the measured battery current to determine a difference, or error. A PI module comprising proportional and integral components, well known in the art, generates a feedback signal or value by integrating the difference after scaling it using a proportional gain. The feedback value is added to the feed-forward value to generate a current value which, if smaller than the charging current limit, becomes the target current. The battery current demand may be determined by dividing the battery charge power limit by the battery voltage. The battery current demand may be calculated by the closed loop current control, provided by the BMU, or in any other manner.

As described with reference to the figures, addition of a feedback loop enhances the performance of the charger to charge the battery/(ies) of the vehicle and thus increase the speed of charging to enable the vehicle to more quickly resume operations. Additionally, the improved charging logic increases predictability of the estimation of charging time, which enhances scheduling and routing of electric vehicles, for example buses.

The scope of the invention is to be limited by nothing other than the appended claims, in which reference to an element in the singular is not intended to mean “one and only one” unless explicitly so stated, but rather “one or more.”

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The embodiments and examples described above may be further modified within the spirit and scope of this disclosure. This application covers any variations, uses, or adaptations of the invention within the scope of the claims.

1-20. (canceled)

21. A method to charge an electric vehicle having a battery operable to power an electric traction system, the method comprising:
connecting the battery to a charger, wherein the electric vehicle includes a powertrain controller communicatively connected to the battery and the charger when the battery is connected to the charger; and
by the powertrain controller:
determine a feed-forward demand current;
receive a measured battery current indicative of a current received by the battery from the charger;
determine a current feedback based on an integral of a difference between the measured battery current and the feed-forward demand current; and
determine a target current based on the sum of the feed-forward demand current and the current feedback; and
command the charger to supply the target current to the electric vehicle.

22. The method of claim 21, wherein the feed-forward demand current comprises a power demand divided by a battery voltage, and the power demand is based on a sum of a battery charge power limit of the battery and an accessory power draw of an accessory electrically connected to a high voltage bus of the electric vehicle.

23. The method of claim 22, wherein the target current is the smaller of the sum and a charging hardware limit.

24. The method of claim 22, wherein the accessory is a reporting accessory.

25. The method of claim 23, wherein the powertrain controller includes a proportional-integral module operable to determine the current feedback based on the integral of the difference as a function of a proportional value and to output a current feedback value indicative of the current feedback.

26. The method of claim 25, wherein the powertrain controller determines the target current based on the sum of the feed-forward demand current and the current feedback value.

27. The method of claim 26, wherein the powertrain controller sets the current feedback to zero if the charging hardware limit is less than the sum.

28. A powertrain controller to control charging of an electric vehicle having a battery operable to power an electric traction system, the powertrain controller comprising charging logic operable to implement a method according claim 21.

29. An electric vehicle comprising: an electric traction system; a battery connected to power the electric traction system; and a powertrain controller comprising charging logic operable to implement a method according claim 21.

30. The electric vehicle of claim 29, further comprising a reporting accessory communicatively coupled to the powertrain controller to provide an accessory power draw to the powertrain controller.

31. A powertrain controller to control charging of an electric vehicle having a battery operable to power an electric traction system, the powertrain controller comprising a charging logic operable to:
determine a feed-forward demand current;
receive a measured battery current indicative of a current received by the battery from a charger;
determine a current feedback based on an integral of a difference between the measured battery current and the feed-forward demand current;
determine a target current based on the sum of the feed-forward demand current and the current feedback; and
generate a target current command for the charger to supply the target current to the electric vehicle.

32. The powertrain controller of claim 31, wherein the feed-forward demand current comprises a power demand divided by a battery voltage, and the power demand is based on a sum of a battery charge power limit of the battery and an accessory power draw of an accessory electrically connected to a high voltage bus of the electric vehicle.

33. The powertrain controller of claim 32, wherein the target current is the smaller of the sum and a charging hardware limit.

34. The powertrain controller of claim 33, wherein the charging logic includes a proportional-integral module operable to determine the current feedback based on the integral of the difference as a function of a proportional value and to output a current feedback value indicative of the current feedback.

35. The powertrain controller of claim 34, wherein at least one of:
the charging logic is operable to determine the target current based on the sum of the feed-forward demand current and
the current feedback value and the powertrain controller sets the current feedback to zero if the charging hardware limit is less than the sum.

36. An electric vehicle comprising:
an electric traction system;
a battery connected to power the electric traction system; and
a powertrain controller to control charging of the battery when the battery is connected to a charger, the powertrain controller comprising a charging logic operable to:
determine a feed-forward demand current;
receive a measured battery current indicative of a current received by the battery from the charger;
determine a current feedback based on an integral of a difference between the measured battery current and the feed-forward demand current;
determine a target current based on the sum of the feed-forward demand current and the current feedback; and
generate a target current command for the charger to supply the target current to the electric vehicle.

37. The electric vehicle of claim 36, wherein the feed-forward demand current comprises a power demand divided by a battery voltage, and the power demand is based on a sum of a battery charge power limit of the battery and an accessory power draw of an accessory electrically connected to a high voltage bus of the electric vehicle.

38. The electric vehicle of claim 37, wherein the target current is the smaller of the sum and a charging hardware limit.

39. The electric vehicle of claim 36, wherein at least one of
the charging logic includes a proportional-integral module operable to determine the current feedback based on the integral of the difference as a function of a proportional value and to output a current feedback value indicative of the current feedback and
the charging logic is operable to determine the target current based on the sum of the feed-forward demand current and the current feedback value.

40. The electric vehicle of claim 37, further comprising a reporting accessory communicatively coupled to the powertrain controller to provide the accessory power draw to the powertrain controller.
